(19) United States
(12) Patent Application Publication
(10) Pub. No.: US 2023/0294171 A1
(43) Pub. Date: Sep. 21, 2023

(54) ADDITIVE MANUFACTURING SYSTEM WITH ASYMMETRIC GAS FLOW HEAD

(71) Applicant: VulcanForms Inc., Burlington, MA (US)

(72) Inventors: Raghav Aggarwal, Somerville, MA (US); Michael von Dadelszen, Merrimack, NH (US); Alexander Dunbar, Watertown, MA (US); Piotr Liebersbach, Chicopee, MA (US)

(73) Assignee: VulcanForms Inc., Burlington, MA (US)

(21) Appl. No.: 18/184,251

(22) Filed: Mar. 15, 2023

Related U.S. Application Data
(60) Provisional application No. 63/320,897, filed on Mar. 17, 2022.

(51) Int. Cl. B22F 10/322; B22F 12/45; B22F 10/28; B33Y 10/00; B33Y 30/00

(52) U.S. Cl. CPC B22F 10/322; B22F 12/45; B22F 10/28; B33Y 10/00; B33Y 30/00

(57) ABSTRACT

An additive manufacturing system may include a build surface and an optics assembly movable relative to the build surface. The optics assembly may direct laser energy from one or more laser energy sources toward the build surface to melt a portion of the build surface. The system may further comprise a gas flow head operatively coupled to the optics assembly and moveable relative to the build surface. The gas flow head may define a partially enclosed volume between the optics assembly and the build surface. The gas flow head may generate a non-uniform flow of gas through the gas flow head in a direction that is opposite a direction of motion of the optics assembly. A velocity of the gas flow may be sufficient to entrain particles ejected from the melted portion of the layer of material in order to remove the ejected particles from the partially enclosed volume.

### CROSS-REFERENCE TO RELATED APPLICATIONS

This application claims priority under 35 U.S.C. § 119(e) to U.S. Provisional Application Ser. No. 63/320,897, filed Mar. 17, 2022, and entitled “ADDITIVE MANUFACTURING SYSTEM WITH ASYMMETRIC GAS FLOW HEAD,” which is incoporated by reference in it its entirety for all purposes.

### FIELD

Disclosed embodiments are related to additive manufacturing systems and asymmetric gas flow heads.

### BACKGROUND

Many methods of metal additive manufacturing are currently available in the market. The methods can be separated by source of material (powder, wire, film etc.) and form of energy addition to obtain melting/bonding (laser melting, e-beam melting, welding arc, sintering etc.). The resolution, accuracy, and obtainable feature size of the end part for a given process is based on the initial material form and the ability to control the energy placement for metal fusion. The effective rate of a given process is typically limited by the ability to deliver energy into the build surface in a controlled manner.

In a selective laser melting processes for metal additive manufacturing, one or more laser spots are typically scanned over a thin layer of metal powder. The metal powder that is scanned with the laser spot is melted and fused into a solid metal structure. Once a layer is completed, the structure is indexed, a new layer of metal powder is laid down and the process is repeated. If an area is scanned with the laser spot on the new layer that is above a previous scanned area on the prior layer, the powder is melted and fused onto the solid material from the prior layer. This process can be repeated many times in order to build up a three-dimensional shape of almost any form.

Both single laser and multi-laser systems are used in selective laser melting processes. For example, some systems use a pair of galvanometer mounted mirrors to scan each laser beam over the desired pattern on the build surface. Some systems use motion stages to scan the laser over the build surface. Moreover, some systems use a combination of motion stages and galvanometers to scan the laser over the build surface. Systems that use galvanometers as part of the scanning method often use f-theta or telecentric lenses to help keep the incident angle of the laser beam onto the build surface as close to perpendicular as possible for a given build surface size. The spacing between the final optical component of any laser path (e.g., the final optics, galvanometer, mirror, telecentric lens or f-theta lens) may be on the order of a few millimeters up to a hundred centimeters or more.

### SUMMARY

In some embodiments, an additive manufacturing system may comprise a build surface, one or more laser energy sources, and an optics assembly movable relative to the build surface. The optics assembly may be configured to direct laser energy from the one or more laser energy sources toward the build surface. Exposure of a layer of material on the build surface to the laser energy may melt at least a portion of the layer of material. The system may further comprise a gas flow head operatively coupled to the optics assembly and moveable relative to the build surface. The gas flow head may define a partially enclosed volume between the optics assembly and the build surface. The gas flow head may be configured to generate a non-uniform flow of gas through the gas flow head in a direction that may be at least partially opposite a direction of motion of the optics assembly. A velocity of the gas flow may be sufficient to entrain particles ejected from the melted portion of the layer of material in order to remove the ejected particles from the partially enclosed volume.

In other embodiments, an additive manufacturing system may comprise a build surface, one or more laser energy sources, and an optics assembly movable relative to the build surface. The optics assembly may be configured to direct laser energy from the one or more laser energy sources toward the build surface. Exposure of a layer of material on the build surface to the laser energy may melt at least a portion of the layer of material. The system may further comprise a gas flow head operatively coupled to the optics assembly and moveable relative to the build surface. The gas flow head may define a partially enclosed volume between the optics assembly and the build surface. The gas flow head may comprise a first duct oriented at a first angle relative to the build surface, and a first gas outlet. The first gas outlet may be fluidly coupled with a first gas flow generator configured to generate a gas flow through the first gas outlet. The gas flow head may further comprise a second duct oriented at a second angle relative to the build surface, and a second gas outlet. The second gas outlet may be fluidly coupled with a second gas flow generator configured to generate a gas flow through the second gas outlet. The first duct and the second duct may be configured to be selectively moved between an extended configuration proximate to the build surface and a retracted configuration spaced apart from the build surface.

In further embodiments, a method for additive manufacturing may comprise directing laser energy from one or more laser energy sources through an optics assembly and toward a build surface. The optics assembly may be movable in a scan direction relative to the build surface. The method may further comprise exposing a layer of material on the build surface to the laser energy and melting at least a portion of the layer of material due to exposure of the portion to the laser energy. Additionally, the method may include generating a non-uniform flow of gas that may flow through a gas flow head in a direction that may be at least partially opposite a direction of motion of the optics assembly. The method may also include entraining particles ejected from the melted portion of the layer of material in the non-uniform flow of gas in order to remove the ejected particles from the partially enclosed volume.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of an additive manufacturing system including a gas flow head according to one embodiment;

FIG. 2 is a schematic representation of an optics unit and a gas flow head according to one embodiment;

FIG. 3 is a top view of a gas flow head according to one embodiment;

FIG. 4 is a side view of a gas flow head according to one embodiment;

FIG. 5A is a perspective view of a duct of a gas flow head according to one embodiment, the duct having a shutter in an open configuration;

FIG. 5B is a perspective view of a duct of a gas flow head according to one embodiment where the duct has a shutter in a closed configuration;

FIG. 6A is a schematic representation of a first configuration of a gas flow head according to one embodiment;

FIG. 6B is a schematic representation of a second configuration of the gas flow head of FIG. 6A;

FIG. 7 is a schematic representation illustrating a flow of gas through a gas flow head according to one embodiment; and

FIG. 8 is a process flow diagram illustrating a method of additive manufacturing according to one embodiment.

### DETAILED DESCRIPTION

The inventors have recognized and appreciated that many factors may affect the behavior of a melt pool in a selective laser melting system at the point of laser incidence on a layer of powdered material on a build surface. Dynamics within the melt pool may result in the generation of fumes and some degree of gasification of the molten metal. Moreover, the gasification and rapid expansion of powdered and molten metal can also cause the melt pool to eject particles upward and away from the melt pool. Various types of particles ejected from a melt pool during a laser melt process (e.g., individual powder particles, partially fused powder particles, cooled molten droplets, fumes from the melt pool) may cause a number of problems during the process. For example, ejected particles may result in delamination between build layers, inclusions, overbuilds, voids, or distortion in a final built component. Ejected particles may also result in damage to the system, including damage to a recoating blade of the system or damage to an optical component of the system.

The inventors have recognized and appreciated numerous benefits associated with additive manufacturing systems that include a gas flow across the powder bed surface. Such gas flows may address one or more issues caused by ejected particles during an additive manufacturing process. However, as build volumes and the size of build surfaces increases, it becomes increasingly more difficult to produce a uniform gas field over the build surface that is both sufficiently fast enough to entrain most particles while keeping surface velocities low enough across the build surface to prevent deformation or disturbance of the powder surface. Accordingly, the inventors have recognized and appreciated the benefits associated with additive manufacturing systems constructed and arranged to produce a local gas flow close to the melt pool with a relatively high gas flow velocity in a desired local area but with a relatively low total circulating volume of gas. This non-uniform gas flow within a gas head may help to entrain particles ejected from the melt pool without disturbing the powder surface.

The inventors have observed that when the laser(s) scan across a powder layer in a particular scan direction or direction of motion relative to a build surface, more particles may be ejected behind the melt pool than are ejected ahead of the melt pool and more of the particles may be ejected in a direction at least partially opposite from the direction of motion of the melt pool. In other words, particles are ejected asymmetrically in relation to the direction of motion of the laser(s) in that more particles are ejected in a direction that is at least partially opposite the direction of motion. Additionally, the inventors have appreciated that as the number of laser spots and corresponding number of melt pools increases, the overall mass or volume of total ejected particles also increases. Accordingly, in a system with a large number of laser spots moving in a coordinated direction of motion for the multiple laser spots, the overall mass of ejecta may be significantly greater behind the melt pool than in front of the melt pool in relation to the direction of motion.

This asymmetric or non-uniform distribution of ejected particles may exceed the entrainment capacity of a gas flow head that is symmetric or uniform with respect to the direction of motion. This may allow some particles to escape the gas flow and land on the powder bed surface. When the total mass of ejected particles is increased (including, for example, when the number of laser spots or melt pools is increased), the asymmetric distribution of ejected particles may exceed the entrainment capacity of a symmetric gas flow head in some applications.

In view of the foregoing, the inventors have recognized and appreciated the benefits associated with additive manufacturing systems constructed and arranged to produce a non-uniform flow of gas through a gas head. Specifically, in some embodiments a velocity of a gas flow through a gas head, and a corresponding entrainment capacity of the gas flow, may be greater behind the melt pool than ahead of the melt pool relative to a direction of motion of the melt pool across a build surface of the system.

In view of the above, in some embodiments, an additive manufacturing system may include a gas flow head positioned between an optics assembly (e.g., one or more optical components of the laser beam system) and build surface. The gas flow head may be mounted to the optics assembly (e.g., to one or more motion stages that produce at least some of the scanning motion of the incident laser beam) in some embodiments. The gas flow head may include one or more ducts to facilitate generation of a non-uniform gas flow through the gas flow head. In some embodiments, each duct may be moveable to selectively increase or decrease a spacing between a duct and the build surface in order to produce a desired flow of gas, as will be described below.

Depending on the particular embodiment, a flow velocity of gas within the gas flow head (e.g., across an area corresponding to an aperture in the gas flow head) may be between about 0.5 meters per second and about 3 meters per second. For example, the flow velocity may be between 0.5 meters per second and 1.5 meters per second. In one embodiment, an area over which the gas flows within the gas flow head may be about 10 cm² to 100 cm², and accordingly, a flow rate of gas into the gas flow head may range from about 0.5 liters/s to about 15 liters/s. In some embodiments a flow rate of the return gas out of the gas flow head may range from about 0.5 to about 3 times the flow rate of supply gas into the gas flow head. However, it should be understood that other flow velocities, gas flow areas, and/or flow rates of supply gas and/or return gas may be suitable, as the current disclosure is not limited in this regard.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

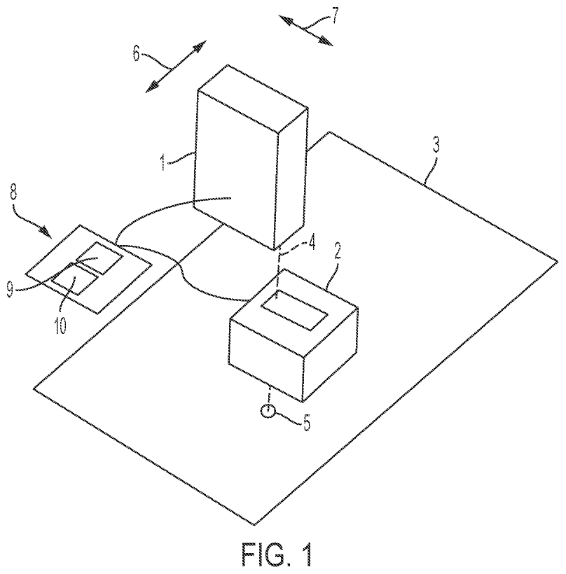

FIG. 1 depicts one embodiment of an additive manufacturing system comprising an optical assembly such as optics unit 1 that may direct one or more incident laser beams 4 through a gas flow head 2 and onto a build surface, such as powder bed surface 3. The incident laser beam(s) 4 may produce one or more melt pools 5 on the build surface. The position of the melt pool 5 on the build surface may be controlled by moving the optics unit 1 along directions 6 and 7 relative to the build surface, for example using motion stages. However, embodiments in which galvomirrors, or other appropriate methods and systems for moving the laser beams relative to the build surface and gas flow head are used are also contemplated as the disclosure is not limited in this manner.

In some embodiments, the various embodiments of an additive manufacturing system disclosed herein may include one or more controllers 8 as shown in FIG. 1. As shown in the figure the one or more controllers may be operatively coupled with one or more controllable portions of the optics unit 1 and/or the gas flow head 2. This may include various components such as actuators, valves, gas flow generators, and/or any other appropriate component. In either case, the controller may include one or more processors 9 and associated non-transitory computer readable memory 10. The memory may include computer readable instructions that when executed by the one or more processors cause the additive manufacturing system to perform any of the methods and processes disclosed herein.

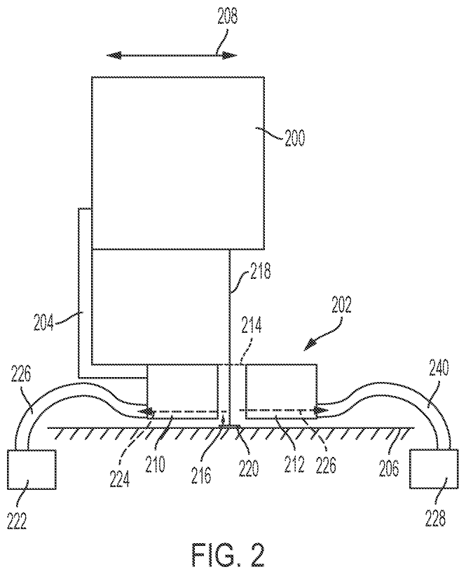

FIG. 2 depicts a schematic cross-sectional side view of an optics unit 200 and gas flow head 202. The gas flow head 202 may be attached to the optics unit 200 with a mounting bracket 204 or other appropriate attachment. In this embodiment, the mounting bracket 204 may maintain the gas flow head 202 in a fixed position relative to the optics unit 200. In this manner, as the optics unit 200 is scanned over a build surface, such as powder bed surface 206, the gas flow head 202 may also be scanned over the powder bed surface 206 in a direction of motion 208 at substantially the same velocity as the optics unit. The gas flow head 202 may include a first portion 210 and a second portion 212. The first portion 210 and the second portion 212 may be at least partially separated by an aperture 214 disposed therebetween. The overall construction may also include a volume 216. The volume 216 may be at least partially enclosed by the gas flow head 202 above the powder bed surface 206. One or more incident laser beams 218 may pass from the optics unit 200, through the aperture 214 and the partially enclosed volume 216, and onto the powder bed surface 206. Depending on the embodiment, the aperture may either correspond to an opening or an optically transparent material forming a window that the laser energy may pass through without being substantially absorbed by the window. Energy from the one or more laser beams 218 may create one or more melt pools 220 on the powder bed surface 206.

Any appropriate construction may be used to draw a flow of gas from the partially enclosed volume 216 through the gas flow head 212 to evacuate particles, fumes, or gasses ejected from the melt pool 220. For example, in the embodiment shown in FIG. 2, a first vacuum supply 222 may draw a first flow of gas 224 through the first portion 210 of the gas flow head via a first gas outlet 226. A second vacuum supply 228 may draw a second flow of gas 230 through the second portion 212 of the gas flow head via a second gas outlet 240.

While the embodiment depicted in FIG. 2 shows two separate vacuum supplies, it should be appreciated that in various embodiments, any appropriate number of vacuum supplies may be used, including a single vacuum supply or more than two vacuum supplies. Additionally, while the embodiment of FIG. 2 uses vacuum supplies to generate the flow of gas away from the melt pool, it should be understood that any appropriate method or structure for generating a flow of gas may be used, including, but not limited to, one or more fans, blowers, compressed gas supplies, mechanical compressor systems, vacuum pumps, combinations of the forgoing, and/or any other gas flow generator capable of generating a flow of gas through the gas flow head of any of the embodiments described herein. In embodiments with more than one gas flow generator, each gas flow generator may be controlled independently, or they may be cooperatively controlled in order to achieve a desired flow of gas through the gas flow head.

In addition to the above, while the embodiment described in FIG. 2 includes a gas flow head coupled to an optics unit by a bracket such that the optics unit and gas flow head move relative to a powder bed at substantially the same velocity, it should be understood that other arrangements may also be used. For example, in some embodiments, the gas flow head and optics unit may be separately coupled to a common gantry system (or other suitable structure) that scans both the optics unit and gas flow head across the powder bed at substantially the same velocity. In other embodiments, the optics unit and gas flow head may have separate respective gantry systems (or other suitable actuatable systems) that are configured to move each of the optics unit and gas flow head relative to the build surface. In such embodiments, these separate systems may be operated such that the gas flow head and optics unit may be scanned across the powder bed at substantially the same velocity and direction.

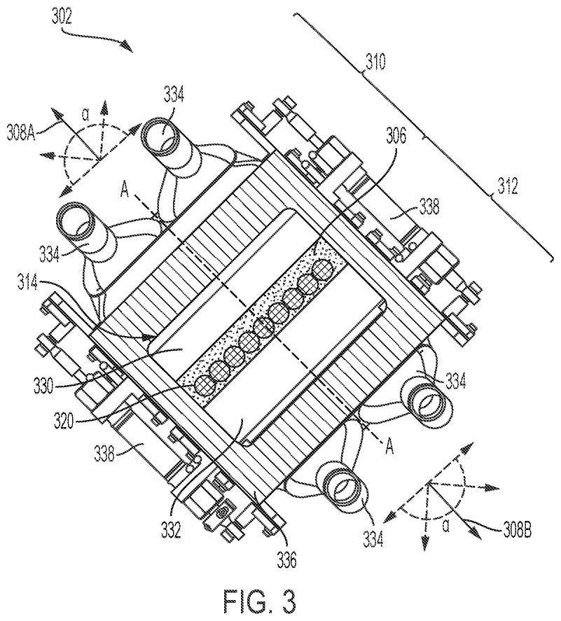

FIG. 3 depicts a top view of one embodiment of a gas flow head 302. The gas flow head may have an axis A-A extending from a first side 310 of the gas flow head to a second side 312 of the gas flow head. The gas flow head 302 may be configured to move in a first direction of motion 308A or a second direction of motion 308B. It will be appreciated that the first and second directions of motion 308A, 308B may be any directions, depending upon the embodiment and configuration. For example, the first and second directions of motion 308A, 308B may be aligned with the axis A-A and may be at least partially opposite to one another in some embodiments. Alternatively, the first and second directions of motion 308A, 308B may form a scan angle a with the axis A-A. For example, the optics head and gas head of a system may be scanned in multiple different directions and angles during subsequent scans of a build layer in some embodiments. In some embodiments, the scan angle a may be greater than or equal to 0°, 5°, or 15°, and/or any other appropriate angle. Additionally, the scan angle a may be less than or equal to 45°, 70°, or 90°, and/or any other appropriate angle. Combinations of the foregoing are contemplated including, for example, greater than or equal to 0° and less than or equal to 90°, greater than or equal to 5° and less than or equal to 45°, and/or any other appropriate combination of the foregoing. Of course, while particular ranges and values for the scan angle are provided above, it should be understood that other ranges both greater than and less than those noted above are also contemplated as the disclosure is not limited in this fashion. It should also be noted that the first and second directions of motion 308A, 308B need not be directly opposed to one another. For example, the first direction of motion 308A may be at a first scan angle of 5°, and the second direction of motion 308B may be at a second scan angle of 40° .

When the gas flow head 302 moves in the first direction of motion 308A, the first portion 310 may be a leading portion in that the first portion 310 is moving at least partially ahead of the one or more melt pools 320. The second portion 312 may be a trailing portion in that the portion side 312 is moving at least partially behind or trailing the one or more melt pools 320. When the gas flow head 302 moves in the second direction of motion 308B, the second portion 312 may be a leading portion and the first portion 310 may be a trailing portion.

The first portion 310 may include a first duct 330 and the second portion 312 may include a second duct 332. Each of the first duct 330 and the second duct 332 may be fluidly coupled to at least one gas flow generator (not shown) via at least one gas outlet 334 fluidly coupled to the gas outlet. The first duct 330 and the second duct 332 may be coupled to the same gas flow generator, or each duct may be coupled to a separate gas flow generator.

A duct, or any component thereof (such as a blade, as described below), may be formed of any appropriate material. In some embodiments, a duct or a component thereof may be formed of a metal, such as copper or a copper alloy, such that the duct or blade may resist damage from or adhesion to high temperature ejecta. In some embodiments, a duct, or a component thereof, may be formed of a copper alloy, aluminum, aluminum alloy, steel, titanium, or any appropriate metal or other material such as ceramics or polymers. In some embodiments, a duct or a component thereof may be coated in a heat-resistant non-stick material such as polytetrafluoroethylene (PTFE).

In the depicted embodiment, the gas flow head 302 may include a top portion 336. The top portion 336 may include an aperture 314. The aperture 314, which may be an opening or an optically transparent window, which may allow one or more laser beams to pass through the gas flow head to create one or melt pools 320 on a build surface, such as a powder bed surface 306 below the gas flow head 302.

The gas flow head 302 may include one or more actuators 338 operably coupled to at least one component of the gas flow head 302, including the first duct 330 and/or the second duct 332, in order to change a position of the at least one component as elaborated on further below. For example, a first actuator may selectively change a position of the first duct 330 relative to the powder bed surface 306 or a melt pool 320. The actuator or actuators 338 may be any appropriate type of actuator, including linear actuators, hydraulic actuators, electric motors, electric actuators, pneumatic actuators, combinations of the forgoing, and/or any other appropriate type of actuator. The actuator or actuators 338 may be operatively coupled to the at least one component of the gas flow head through any appropriate type of coupling including linear bearings, direct mountings on linear actuators, gears, rack-and-pinion, rotatable connections, linkages, combinations of the forgoing, and/or any other appropriate coupling.

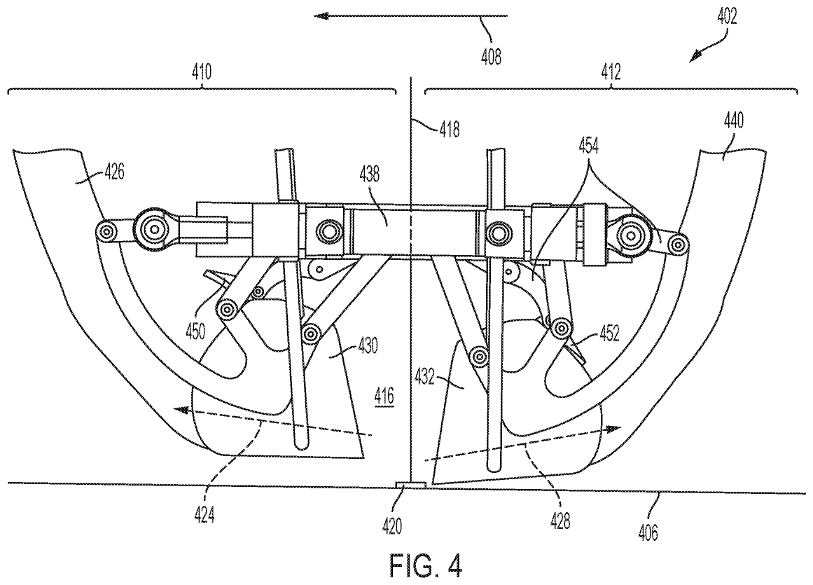

FIG. 4 shows a side view of a gas flow head 402. The gas flow head 402 may define a partially enclosed volume 416 along a path extending between an optics assembly (not shown) and a build surface such as a powder bed surface 406. The gas flow head 402 may be configured to entrain ejecta from a melt pool 420 while the gas flow head 402 is moving in a first scan direction or a first direction of motion 408 across the powder bed surface 406. In the embodiment shown, a first portion 410 of the gas flow head may include a first duct 430 and a second portion 412 located opposite from the first portion may include a second duct 432. The first duct 430 may be fluidly coupled to a gas flow generator (not shown), such as a vacuum supply, via a first gas outlet 426. The second duct 432 may be fluidly coupled to a gas flow generator (not shown), such as a vacuum supply, via a second gas outlet 440. The first duct 430 and the second duct 432 may be coupled to the same gas flow generator, each duct may be coupled to one or more separate gas flow generators. In the depicted embodiment, the first portion of the gas flow head 410 may be located ahead of the melt pool 420 and the second portion of the gas flow head 412 may be located behind the melt pool 420 relative to the current direction of travel 408. When the gas flow head and optics head change direction this relationship may be reversed.

The one or more gas flow generators may cause a first flow of gas 424 to be drawn from the partially enclosed volume 416 through the first duct 430. The one or more gas flow generators may cause a second flow of gas 428 to be drawn from the partially enclosed volume 416 through the second duct 432. Each of the first flow of gas 424 and the second flow of gas 428 may entrain particles, fumes, or other ejecta from the melt pool 420 in order to evacuate the ejecta from the partially enclosed volume 416.

As elaborated on further below, in some embodiments, it may be desirable to provide an increased gas flow through the gas outlets of a duct located behind a path of travel of the one or more melt pools relative to the gas flow through a duct located ahead of the path of travel of the one or more melt pools. For example, it may be desirable to generate a higher gas flow velocity in the second flow of gas 428 than in the first flow of gas 424 to accommodate the increased amount of ejecta oriented in a direction behind a path of travel of the melt pool. This increased flow of gas with a higher velocity may be capable of entraining or evacuating a higher volume or mass of particles, fumes, or other ejecta than a flow of gas with a lower velocity. Accordingly, because a higher volume or mass of ejecta may be ejected on a back side of a melt pool with respect to a direction of motion, such a construction may help to address the uneven distribution of ejecta observed in additive manufacturing systems including high number of melt pools.

In view of the above, in the embodiment of FIG. 4, the gas flow head 402 may be configured to move in a scan direction or a direction of motion 408. Therefore, the first portion 410 may be a leading portion of the gas flow head, and the second side 412 may be a trailing portion disposed behind a path of travel of the one or more melt pools 420. Accordingly, in the area of the melt pool 420, it may be desirable to induce a higher velocity in the second flow of gas 428 than in the first flow of gas 424. As noted above, such an arrangement may result in greater entrainment or evacuation capacity on the back side of the melt pool, where a volume or mass of ejecta may be higher.

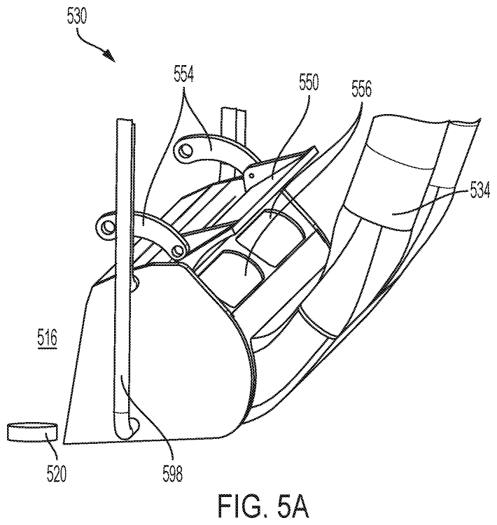

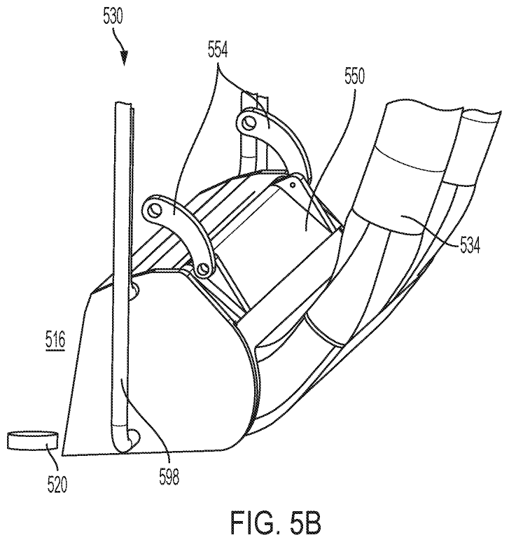

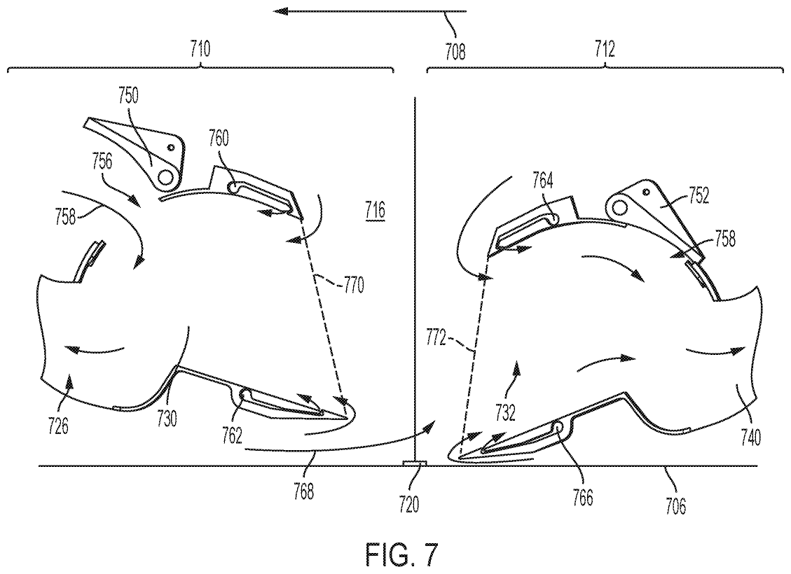

In some embodiments, a gas flow head may be configured to generate a non-uniform flow of gas that flows through the gas flow head in a direction that is at least partially, and in some embodiments substantially, opposite a direction of motion of the optics assembly and gas head. A velocity of the gas flow may be sufficient to entrain particles ejected from the melted portion of the layer of material in order to remove the ejected particles from the partially enclosed volume. Various embodiments of a gas flow head according to the present disclosure may generate such a non-uniform flow of gas in several ways. For example, a vent and a shutter may be included on each duct, the shutter being configured to selectively allow or prevent a vent flow from passing through the vent to selectively change the overall flow of gas from within the at least partially enclosed volume 416 above a melt pool 420 to the associated duct. For example, in the embodiment of FIG. 4, a first shutter 450 of the first duct 430 may be in an open configuration while a second shutter 452 of the second duct 432 may be in a closed configuration. The effect of the shutters and vents will be discussed in more detail with reference to FIGS. 5A, FIG. 5B, and FIG. 7 below.

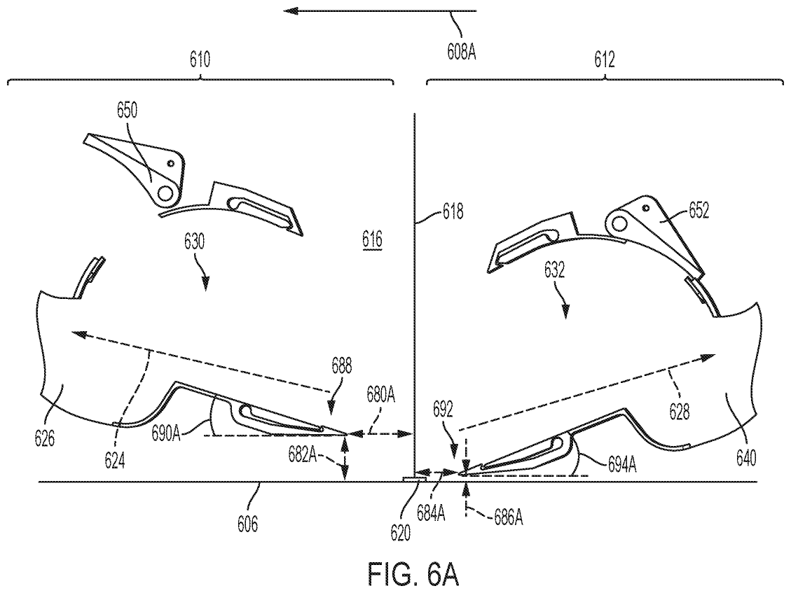

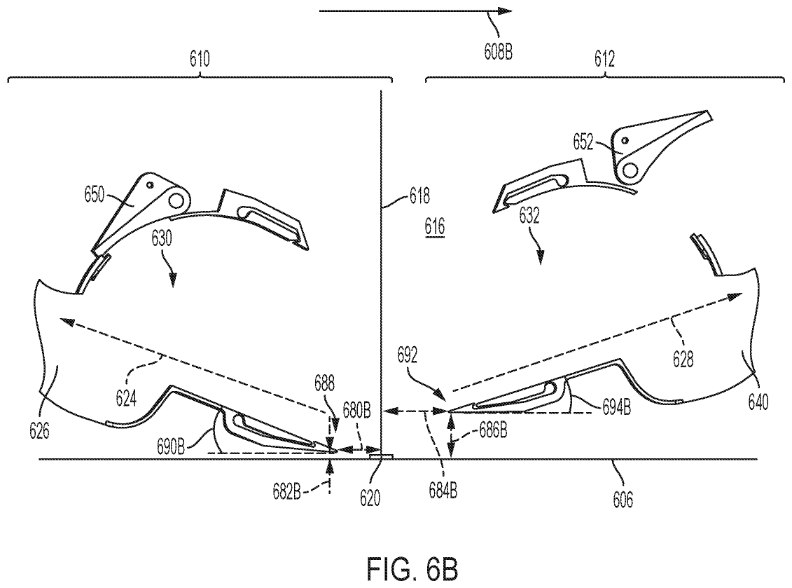

Alternatively or additionally, a gas flow head according to the present disclosure may generate a non-uniform flow of gas by adjusting the relative position or orientation of one or more ducts of the gas flow head in relation to a melt pool. For example, in the embodiment of FIG. 4, the second duct 432 may be positioned closer to the melt pool 420 than the first duct 430. The effect of the duct positioning and orientation will be discussed in more detail with reference to FIG. 6A, FIG. 6B, and FIG. 7 below. For example, the ducts 430 and 432 may be operatively coupled to one or more actuators 438 that are configured to change a spacing between the ducts and the build surface illustrated by powder bed surface 406. In one such embodiment, the duct corresponding to a leading portion of the gas flow head may be in a retracted configuration such that it is spaced from the build surface by a first distance and the duct corresponding to a trailing portion of the gas flow head may be in an extended configuration such that it is spaced from the build surface by a second distance that is less than the first distance (e.g., the trailing duct is closer to the build surface). In the depicted embodiment, the ducts may be connected to an actuator 438 by linkages 454, or other appropriate coupling, that are configured to move the ducts selectively towards and away from the build surface to control the gap present between a bottom most edge of a duct oriented towards the build surface and the build surface. In some embodiments, as shown in the figure, a single double acting actuator may be used to control both ducts such that one duct moves towards the build surface while the other moves away from the build surface. However, embodiments in which separate actuators are used are also contemplated.

Turning to the duct depicted in FIGS. 5A-5B to discuss the effect of the shutters, it will be appreciated that when a gas flow generator such as a vacuum is used to generate a flow of gas through a duct 530 in the embodiment shown, the flow is generated by reducing a pressure within a gas outlet 534. This creates a pressure difference between an interior of the gas outlet and the partially enclosed volume 516 that the overall duct is exposed to, thereby causing gas to flow from the higher pressure environment to the lower pressure environment (i.e., from the partially enclosed volume 516, through the duct 530, and into the gas outlet 534). It will further be appreciated that a given pressure difference may induce a predetermined volumetric flow rate of gas through the duct. Thus, when the vent is open, it may reduce a pressure within a duct, and thus, may reduce a flow of gas from the at least partially enclosed volume to the one or more gas outlets of the duct.

In some embodiments, a shutter 550 may be provided on a duct 530 in order to selectively control the gas flow rate is drawn from the enclosed volume 516 that is proximate to a melt pool 520 into the duct. As shown in FIG. 5A, the shutter may have an open configuration in which a vent 556 is exposed to allow gas to flow through the vent 556 from an area that is spaced apart from the melt pool 520 and at least partially enclosed volume 516. As shown in FIG. 5B, the shutter may also be placed in a closed configuration in which the vent 556 is obstructed to prevent gas flow through the vent. The shutter 550 may be actuated between the open configuration and the closed configuration using any appropriate actuator (not shown) as described above. In some embodiments, the shutter 550 may be actuated by an actuator via one or more linkages 554 operably coupled to the actuator (see FIG. 4) to rotate the one or more shutters about a pivot joint operatively coupled to the duct. Of course, while a pivot connection and motion are shown, any appropriate type of connection and motion of the one or more shutters between an open and closed configuration may be used as the disclosure is not so limited.

When the shutter 550 is in the open configuration as shown in FIG. 5A, at least part of the gas flow into the gas outlet 534 may be provided through the vent 556 which may reduce the flow of gas from the at least partially enclosed volume 516 to the gas outlet. Correspondingly, when the shutter 550 is in the closed configuration of FIG. 5B, the volumetric flow rate may be drawn entirely from the area of the enclosed volume 516 that is proximate to the melt pool 520. Therefore, a volumetric flow rate of gas that is drawn from the area of the melt pool may be greater when the shutter is in the closed configuration than when the shutter is in the open configuration. Accordingly, a velocity of the flow of gas in the area of the melt pool towards the duct may be greater when the shutter is in the closed configuration than when the shutter is in the open configuration.

Turning to the gas flow head depicted in FIGS. 6A-6B, the effect of a position of a duct relative to a build surface or a melt pool thereon will now be discussed. It will first be appreciated that a flow of gas from a partially enclosed volume through a duct of a gas flow head as described herein may have a higher velocity at a point in the partially enclosed volume that is closer to the duct than at a point that is further from the duct. Accordingly, as shown in FIG. 6A, positioning a first duct 630 to be further from a melt pool may reduce a velocity of a first flow of gas 624 at a point near the melt pool 620 on a first side 610 of the melt pool which may be ahead of the melt pool relative to a direction of motion of the melt pool and gas flow head. Conversely, positioning a second duct 632 to be closer to the melt pool 620 may increase a velocity of a second flow of gas 628 at a point near the melt pool 620 on a second side 612 located behind a path of travel of the melt pool and gas flow head. Therefore, in the embodiment of FIG. 6A, the relative positions of the first duct 630 and the second duct 632 may cause a velocity of a second flow of gas 628 to be higher than a velocity of a first flow of gas 624 in an area proximate to the melt pool 620. Additionally, in some embodiments, the first gas flow may be at least partially oriented in a direction of travel of the one or more melt pools and the gas flow head and the second gas flow may be at least partially oriented in an opposite direction.

As noted previously, in some embodiments, it may be beneficial to change the position of either or both of a first duct and a second duct. For example, if a gas flow head may be configured to move in multiple directions, it may be beneficial to change the positions of the ducts in response to a change in a direction of motion or a scan direction. This may facilitate the maintenance of a higher velocity on a back side of a melt pool in relation to a direction of motion or scan direction, even when the direction of motion or scan direction changes.

For example, in FIG. 6A, a gas flow head is configured to move in a direction of motion 608A. In this configuration, a first side 610 of the gas flow head may include a first duct 630. In the configuration shown, the first side 610 may be on a leading side of the gas flow head, in that the first duct 630 may be at least partially ahead of a melt pool 620 when the gas flow head moves in the direction of motion 608A. A second side 612 of the gas flow head may include a second duct 630. In the configuration shown, the second side 612 may be on a trailing side of the gas flow head, in that the second duct 632 may be at least partially behind the melt pool 620 when the gas flow head moves in the direction of motion 608A.

In the configuration shown and for the reasons described above, it may be desirable in some circumstances to move the second duct 632 to be closer to the melt pool 620, and to move the first duct 630 to be further from the melt pool 620. In some embodiments, each duct may be actuated by an actuator or an actuation system as described elsewhere herein to control their positions relative to the melt pool 620. In some embodiments, each duct may be selectively moveable between an extended configuration and a retracted configuration. In the extended configuration, a duct may be proximate to a build surface or a melt pool. In the retracted configuration, the duct may be spaced apart from the build surface or the melt pool by a larger distance than in the extended configuration.

For example, in the embodiment and configuration shown in FIG. 6A, the first duct 630 may be spaced apart from the melt pool 620 by a first separation distance. The first separation distance may be taken as any direct or indirect measure of distance between the first duct 630 and the melt pool 620, or as any composite of multiple measures of distance therebetween. For example, a first separation distance may be characterized by a first horizontal distance 680A and a first vertical distance 682A. The first horizontal distance 680A may be a horizontal distance between a tip of the first duct 630 and a laser beam 618 which may form the melt pool 620. The first vertical distance 682A may be a vertical distance between the tip of the first duct 630 and build surface such as a powder bed surface 606 on which the melt pool 620 is formed.

Similarly, the second duct 632 may be spaced apart from the melt pool 620 by a second separation distance. The second separation distance may be taken as any direct or indirect measure of distance between the second duct 632 and the melt pool 620, or as any composite of multiple measures of distance therebetween. For example, a second separation distance may be characterized by a second horizontal distance 684A and a second vertical distance 686A. The second horizontal distance 684A may be a horizontal distance between a tip of the second duct 632 and the laser beam 618. The second vertical distance 686A maybe a vertical distance between the tip of the second duct 632 and the powder bed surface 606.

In the configuration of FIG. 6A, the first duct 630 may be in a retracted configuration and the second duct 632 may be in an extended configuration, such that the second separation distance may be less than the first separation distance. Accordingly, the first horizontal distance 680A may be a retracted horizontal distance; the first vertical distance 682A may be a retracted vertical distance; the second horizontal distance 684A may be an extended horizontal distance; and the second vertical distance 686A may be an extended vertical distance. This configuration may allow the second flow of gas 628 to entrain a higher volume or mass of ejecta on the trailing side of the melt pool 620 when the gas flow head moves in the first direction of motion 608A.

According to some embodiments, a vertical distance relative to a direction of gravity between a bottom most edge of a duct oriented towards a build surface and the build surface when the duct is in an extended configuration proximate to the build surface may be greater than or equal to 0.5 mm, 1 mm, 2 mm, and/or any other appropriate distance. Additionally, the vertical distance relative to a direction of gravity between the duct and the build surface in the extended configuration may be less than or equal to 3 mm, 4 mm, 5 mm, and/or any other appropriate distance. Combinations of the foregoing are contemplated including, for example, a spacing between the duct and build surface that is greater than or equal to 0.5 mm and less than or equal to 5 mm, greater than or equal to 1 mm and less than or equal to 2 mm, and/or any other appropriate combination of the foregoing. Of course, while particular ranges for the extended vertical distance are provided above, it should be understood that other ranges both greater than and less than those noted above are also contemplated as the disclosure is not limited in this fashion.

According to some embodiments, a horizontal distance relative to a direction of gravity between an edge of the duct closest to a melt pool and the melt pool when the duct is in an extended configuration proximate to the build surface may be greater than or equal to 2 mm, 5 mm, 10 mm, and/or any other appropriate distance. Additionally, the horizontal distance may be less than or equal to 20 mm, 12 mm, 7 mm, and/or any other appropriate distance. Combinations of the foregoing are contemplated including, for example, a spacing between a melt pool and the closest edge of a duct in an extended configuration that is greater than or equal to 2 mm and less than or equal to 20 mm, greater than or equal to 5 mm and less than or equal to 12mm, and/or any other appropriate combination of the foregoing. Of course, while particular ranges for the extended horizontal distance are provided above, it should be understood that other ranges both greater than and less than those noted above are also contemplated as the disclosure is not limited in this fashion.

According to some embodiments, a retracted vertical distance relative to a direction of gravity when a duct is spaced apart from a build surface may be greater than or equal to 10 mm, 12 mm, 15 mm, and/or any other appropriate distance. Additionally, the vertical distance may be less than or equal to 17 mm, 20 mm, 25 mm, and/or any other appropriate distance. Combinations of the foregoing are contemplated including, for example, greater than or equal to 10 mm and less than or equal to 25 mm, greater than or equal to 15 mm and less than or equal to 17 mm, and/or any other appropriate combination of the foregoing. Of course, while particular ranges for the vertical distance between a bottom portion of a duct oriented towards the build surface and the build surface in the retracted spaced apart configuration are provided above, it should be understood that other ranges both greater than and less than those noted above are also contemplated as the disclosure is not limited in this fashion.

According to some embodiments, a horizontal distance relative to a direction of gravity between a melt pool and an edge of a duct may be greater than or equal to 3 mm, 5 mm, 10 mm, and/or any other appropriate distance when the duct is in the retracted configuration such that it is spaced apart from the melt pools. Additionally, the horizontal distance in the retracted configuration may be less than or equal to 50 mm, 15 mm, 10 mm, 5 mm, and/or any other appropriate distance. Combinations of the foregoing are contemplated including, for example, greater than or equal to 3 mm and less than or equal to 50 mm, greater than or equal to 5 mm and less than or equal to 10 mm, and/or any other appropriate combination of the foregoing. Of course, while particular ranges for the retracted horizontal distance are provided above, it should be understood that other ranges both greater than and less than those noted above are also contemplated as the disclosure is not limited in this fashion.

In addition to adjusting a separation distance of a duct relative to the powder bed surface and/or the one or more melt pools formed thereon, it may be desirable to adjust an angle between a duct or a component thereof and the powder bed surface. In some embodiments, a duct may include a blade to define a flow path into, through, or around the duct. For example, the first duct 630 may include a first blade 688 on a bottom portion of the first duct. The first blade 688 may be disposed at a first blade angle 690A with respect to the powder bed surface 606. Similarly, the second duct 632 may include a second blade 692 on a bottom portion of the second duct. The second blade 692 may be disposed at a second blade angle 694A with respect to the powder bed surface 606. As will be described with reference to FIG. 7 below, adjustment of a blade angle may be desirable in order to adjust the flow of gas through a gas flow head. For example, a blade angle or duct angle may be adjusted in order to facilitate or inhibit a flow of gas between a duct and a volume above a powder bed surface.

In some embodiments, an angle between a powder bed surface and a duct or a blade thereof may be greater than or equal to 5°, 10°, 15°, and/or any other appropriate angle. Additionally, the blade angle or duct angle may be less than or equal to 20°, 30°, 45°, and/or any other appropriate distance. Combinations of the foregoing are contemplated including, for example, greater than or equal to 5° and less than or equal to 45°, greater than or equal to 10° and less than or equal to 20°, and/or any other appropriate combination of the foregoing. Of course, while particular ranges for the blade angle or duct angle are provided above, it should be understood that other ranges both greater than and less than those noted above are also contemplated as the disclosure is not limited in this fashion.

Each of the first separation distance, the second separation distance, the first blade angle, and the second blade angle may be adjustable using an actuation system as described above. For example, adjusting a separation distance (i.e., moving a duct closer to or further from a melt pool) may comprise actuating one or more actuators to move the duct to adjust at least one of a horizontal distance, a vertical distance, and/or an angle of the duct relative to the powder bed surface. Each horizontal distance, vertical distance, or angle may be adjusted individually, or they may be adjusted cooperatively depending on the number of ducts included in a gas head.

As has been described throughout this disclosure, adjustability and actuation may be desired when a gas flow head according to the present disclosure is used in conjunction with an additive manufacturing system which may scan or move in more than one direction. For example, in the configuration shown in FIG. 6B, the embodiment of FIG. 6A has been reconfigured to entrain and evacuate ejecta from the melt pool 620 when the gas flow head moves in a second direction of motion 608B that is substantially opposite to the first direction of motion 698A. In the depicted configuration the first duct 630 is now located on a trailing portion of the gas head and the second duct 632 is on a leading portion of the gas head. Accordingly, the second duct 632 is in a retracted configuration spaced from the melt pool 620 and powder bed surface 606 and the first duct 630 is in the extended configuration proximate to the melt pool 620 and powder bed surface 606. In addition, in the configuration of FIG. 6B, the first shutter 650 of the first duct 630 may be in a closed configuration and a second shutter 652 of the second duct 632 may be in an open configuration. Thus, in contrast with FIG. 6A, in the configuration of FIG. 6B, the first horizontal distance 680B may be an extended horizontal distance; the first vertical distance 682B may be an extended vertical distance; the second horizontal distance 684B may be a retracted horizontal distance; and the second vertical distance 686B may be a retracted vertical distance.

Additionally or alternatively to the above, the blade angles or duct angles may also be reconfigured. For example, a first blade angle 690B of FIG. 6B may be greater than the first blade angle 690A of FIG. 6A to further increase a flow of gas between the first duct 630 and the powder bed surface 606. Similarly, a second blade angle 694B of FIG. 6B may be less than the second blade angle 694A of FIG. 6A in order to reduce a flow of gas between the second duct 632 and the powder bed surface 606 adjacent to the one or more melt pools 620.

These reconfigurations, as compared with FIG. 6A, may be carried out in conjunction with a processor of a controller in communication with one or more actuators, or it may be carried out manually by an operator. For example, a processor may be configured to control an actuator to selectively move a first duct and a second duct between a retracted configuration and an extended configuration based on a direction of motion of an optics assembly or a gas flow head. Additionally or alternatively, the processor actuator may be configured to selectively move a first shutter and a second shutter between an open configuration and a closed configuration based on a direction of motion of an optics assembly or a gas flow head. Additionally or alternatively, a processor of a controller may be configured to operate one or more actuators to selectively change a blade angle or a duct angle based on a direction of motion of an optics assembly or a gas flow head.

FIG. 7 depicts a gas flow diagram illustrating the non-uniformity or asymmetry of flow produced by the above-described features in one embodiment of a gas flow head according to the present disclosure. A first portion 710 of the gas flow head may include a first duct 730 on a first side of a melt pool 720. The first duct 730 may include a first duct opening 770. The first duct opening 770 may be disposed adjacent to and in fluid communication with a partially enclosed volume 716 that is proximate to the melt pool 720 and is on the first side of the melt pool. The first duct 730 may be fluidly coupled to a gas flow generator (not shown) via a first gas outlet 726. The first duct 730 may include a first shutter 750. The first shutter 750 may be in an open position to expose a first vent 756.

The first duct 730 may optionally include at least one gas knife. A gas knife may be provided to increase a velocity of a gas flow into or near an opening of a duct. In some embodiments, a gas knife may provide additional cooling for an interior of a duct to prevent ejecta from adhering to a surface therein. For example, in the embodiment shown, the first duct 730 may include a first top gas knife 760 and a first bottom gas knife 762. Each gas knife may be fluidly coupled to one or more pressurized gas sources through a gas knife supply line (reference number 598, shown in FIGS. 5A-5B). Each gas knife may be configured provide a flow of gas oriented toward the associated gas outlet of the duct. Each gas knife may produce a high velocity gas flow that has an overall velocity greater than an average velocity through the associated duct. For example, as shown in FIG. 7, each of the first top gas knife 760 and first bottom gas knife 762 is oriented toward the first gas outlet 726 in order to produce a high velocity gas flow toward the first gas outlet 726.

In some embodiments, a gas knife may be formed as an integral part of a duct, or as an integral part of a blade of a duct. Alternatively, a gas knife may be included as a separate component attached to a duct or a blade. In some embodiments, a gas knife may be formed as a single piece, for example through computer numerical control machining (CNC), electric discharge machining (EDM) or other appropriate machining technique. In other embodiments, a gas knife may be formed as multiple pieces and assembled into a single component. In some embodiments, a pressurized gas source may provide a gas knife with an inert gas. For example, a pressurized gas source may provide a gas knife with argon, nitrogen, or any appropriate mixture of gasses. In some embodiments, an atmosphere surrounding a gas head within a build volume of an additive manufacturing system may also be substantially comprised of an inert gas such as those listed above (e.g., greater than 90 atomic percentage, greater than 95 atomic percentage, greater than 99 atomic percentage, or any other appropriate percentage of the surrounding atmosphere).

A second portion 712 of the gas flow head may include a second duct 732 on a second side of the melt pool 720. The second duct 732 may include a second duct opening 772. The second duct opening 772 may be disposed adjacent to and in fluid communication with the partially enclosed volume 716 that is proximate to the melt pool 720 and is on the second side of the melt pool 720. The second duct 732 may be fluidly coupled to a gas flow generator (not shown) via a second gas outlet 740. The second duct 732 may include a second shutter 752. The second shutter 752 may be in a closed position to obstruct a second vent 758. The second duct 732 may optionally include at least one gas knife. For example, in the embodiment shown, the second duct 732 may include a second top gas knife 764 and a second bottom gas knife 766, which may operate in a manner similar to that described above.

Because the first shutter 750 is in the open position, a vent flow 758 may be permitted to enter the duct 730 through the first vent 756. As discussed above, this may reduce a volumetric flow rate from the at least partially enclosed volume, and corresponding flow velocity adjacent to the enclosed volume 716 and melt pool 720 through the first duct opening 770.

Because the second shutter 752 is in the closed position, no vent flow may be permitted through the second vent 758. Therefore, a volumetric flow rate through the second duct opening 772 may be greater than the volumetric flow rate through the first duct opening 770. Accordingly, a velocity through the second duct opening 772 may be greater than a velocity through the first duct opening 770. The direction of flow through the second duct opening may be at least partially opposite to that of the direction of motion 708 of the gas flow head and one or more melt pools 720.

The diagram of FIG. 7 also illustrates that a scavenge gas flow 768 may be permitted to flow between a powder bed surface and a duct. In the example shown, the scavenge gas flow 768 may flow between a powder bed surface 706 and the first duct 730. Because of the reduced volumetric flow rate and velocity across the first duct opening 770, some of the scavenge gas flow 768 may be drawn over and across the melt pool 720 and into the second duct 732. As the scavenge gas flow 768 crosses the melt pool 720, the scavenge gas flow 768 may entrain particles, fumes, or other ejecta from the melt pool 720. The scavenge gas flow 768 may carry the ejecta primarily into the second duct 732, thereby facilitating evacuation of the ejecta. In the embodiment shown, the scavenge gas flow 768 may be adjusted by controlling a separation distance (vertical, horizontal, or both), a blade angle, and/or a duct angle of the leading duct located ahead of a direction of motion of the one or more melt pools as described above, for example by using an actuator to control a position of the first duct 730.

The configuration shown in FIG. 7 may produce higher gas velocities in the area around the melt pool 720 on the second side 712 corresponding a trailing side of the melt pool than on the first side 710 corresponding a leading side of the melt pool. For example, when the gas flow head of FIG. 7 is configured to move in a direction of motion 708, the first side 710 may be a front side of the gas flow head and the second side 712 may be a back side of the gas flow head. The higher velocities on the back side of the gas flow head (i.e., behind the melt pool 720) may facilitate the entrainment and evacuation of the higher volume or mass of ejecta that are ejected behind the melt pool 720.

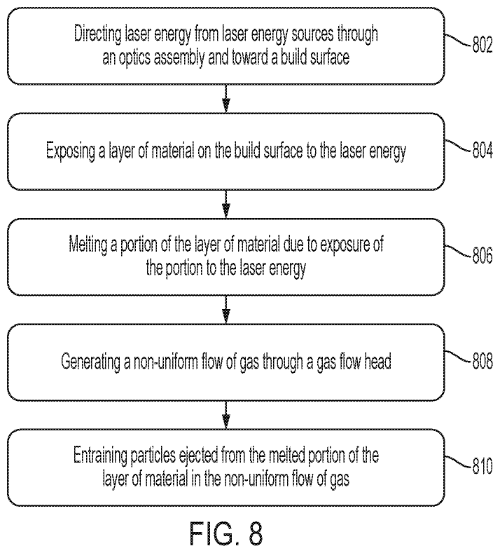

FIG. 8 depicts a process flow diagram illustrating a method of additive manufacturing according to one embodiment. At block 802, laser energy is directed from one or more laser energy sources through an optics assembly and toward a build surface, such as a powder bed surface. In some embodiments, the optics assembly may be moveable in a scan direction relative to the build surface. This may include moving a gas flow head in the scan direction relative to the build surface in sync with the optics assembly in some embodiments. At block 804, a layer of material on the build surface is exposed to the laser energy. At block 806, a portion of the layer of material is melted due to exposure of the portion to the laser energy. At this step, a melt pool may be formed on a powder bed surface. At block 808, a non-uniform flow of gas is generated through a gas flow head in a direction that is at least partially opposite a direction of motion of the optics assembly. This non-uniform flow of gas through the gas flow head may be generated and controlled using any of the systems and/or methods disclosed herein. At block 810, particles ejected from the melted portion of the layer of material are entrained in the non-uniform flow of gas in order to remove the ejected particles from a volume between the optics assembly and the build surface that is at least partially enclosed by the gas flow head.

It will be appreciated that while the present disclosure describes certain structures and methods for generating a non-uniform flow of gas through a gas flow head in detail, other structures and methods are also contemplated. For example, in alternative or additional aspects, a gas flow generation system may be configured to control the relative velocities through the first and second duct. For example, a first vacuum supply that is coupled to a first duct may be controlled to selectively increase or decrease flow through the first duct and a second vacuum supply that is coupled to a second duct may controlled to selectively increase or decrease a flow through the second duct either separately from or in coordination with the first duct. Alternatively or additionally, the relative velocities through the gas flow head may be controlled by controlling relative velocities through one or more gas knives of the gas flow head.

It will further be appreciated that while the present disclosure describes some embodiments as having two ducts, other embodiments may include any appropriate number of ducts. For example, some embodiments may include only a single duct. Further embodiments may include multiple ducts on each side of a gas flow head.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computing device, which may be referred to as a controller herein, or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a programmable logic controller (PLC), an application-specific integrated circuit (ASIC), a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure .

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a build surface;
one or more laser energy sources;
an optics assembly movable relative to the build surface and configured to direct laser energy from the one or more laser energy sources toward the build surface, wherein exposure of a layer of material on the build surface to the laser energy melts at least a portion of the layer of material; and
a gas flow head operatively coupled to the optics assembly and moveable relative to the build surface, wherein the gas flow head defines a partially enclosed volume between the optics assembly and the build surface, wherein the gas flow head is configured to generate a non-uniform flow of gas through the gas flow head in a direction that is at least partially opposite a direction of motion of the optics assembly, wherein a velocity of the gas flow is sufficient to entrain particles ejected from the melted portion of the layer of material in order to remove the ejected particles from the partially enclosed volume.

2. The additive manufacturing system of claim 1, wherein the gas flow head further comprises a first duct oriented at a first angle relative to the build surface.

3. The additive manufacturing system of claim 2, wherein the gas flow head further comprises a second duct oriented at a second angle relative to the build surface.

4. The additive manufacturing system of claim 3, wherein the first duct and the second duct are configured to be selectively moved between an extended configuration proximate to the build surface and a retracted configuration spaced apart from the build surface.

5. The additive manufacturing system of claim 4, further comprising at least one actuator operatively coupled to the first duct and the second duct to selectively move the first duct and the second duct between the retracted configuration and the extended configuration.

6. The additive manufacturing system of claim 5, wherein the at least one actuator is configured to selectively move the first duct and the second duct between the retracted configuration and the extended configuration based on the direction of motion of the optics assembly.

7. The additive manufacturing system of claim 6, wherein, when the first duct is located at least partially ahead of the melted portion of the layer of material relative to the direction of motion of the optics assembly, the at least one actuator is configured to move the first duct into the retracted configuration and to move the second duct into the extended configuration, and wherein, when the second duct is located at least partially ahead of the melted portion of the layer of material relative to the direction of motion of the optics assembly, the at least one actuator is configured to move the first duct into the extended configuration and to move the second duct into the retracted configuration.

8. The additive manufacturing system of claim 2, wherein the first duct includes at least one gas knife oriented towards a gas outlet of the first duct.

9. The additive manufacturing system of claim 1, wherein the gas flow head further comprises a first gas outlet fluidly coupled with a first gas flow generator, wherein the first gas outlet is configured to be disposed behind the melted portion of the layer of material relative to a direction of motion of the optics assembly in at least one operating mode.

10. The additive manufacturing system of claim 1, wherein a velocity of the gas flow is higher on a first side of the gas flow head than on a second side of the gas flow head, wherein the first side is located behind the melted portion of the layer of material relative to a direction of motion of the optics assembly.

11. The additive manufacturing system of claim 1, wherein the gas flow head further comprises an aperture arranged to permit transmission of the laser energy through the gas flow head to the build surface.

12. The additive manufacturing system of claim 1, wherein the gas flow head further comprises at least one vent and at least one shutter, the at least one shutter being configured to be selectively moved between an open configuration allowing gas flow through the first vent and a closed configuration preventing gas flow through the first vent.

13. The additive manufacturing system of claim 12, further comprising at least one actuator operatively coupled to the at least one shutter to selectively move the at least one shutter between the open configuration and the closed configuration.

14. The additive manufacturing system of claim 13, wherein the at least one actuator is configured to selectively move the at least one shutter between the open configuration and the closed configuration based on the direction of motion of the optics assembly.

15. An additive manufacturing system comprising:
a build surface;
one or more laser energy sources;
an optics assembly movable relative to the build surface and configured to direct laser energy from the one or more laser energy sources toward the build surface, wherein exposure of a layer of material on the build surface to the laser energy melts at least a portion of the layer of material; and
a gas flow head operatively coupled to the optics assembly and moveable relative to the build surface, wherein the gas flow head defines a partially enclosed volume between the optics assembly and the build surface, the gas flow head comprising:
a first duct oriented at a first angle relative to the build surface,
a first gas outlet fluidly coupled with a first gas flow generator configured to generate a gas flow through the first gas outlet,
a second duct oriented at a second angle relative to the build surface, and
a second gas outlet fluidly coupled with a second gas flow generator configured to generate a gas flow through the second gas outlet,
wherein the first duct and the second duct are configured to be selectively moved between an extended configuration proximate to the build surface and a retracted configuration spaced apart from the build surface.

16. The additive manufacturing system of 15, wherein the gas flow head further comprises an aperture arranged to permit transmission of the laser energy through the gas flow head to the build surface.

17. The additive manufacturing system of 15, wherein the gas flow head is configured to generate a non-uniform flow of gas that flows through the gas flow head in a direction that is at least partially opposite a direction of motion of the optics assembly, wherein a velocity of the gas flow is sufficient to entrain particles ejected from the melted portion of the layer of material in order to remove the ejected particles from the partially enclosed volume.

18. The additive manufacturing system of claim 17, wherein a velocity of the gas flow is higher on a first side of the gas flow head than on a second side of the gas flow head, the first side being behind the melted portion of the layer of material relative to a direction of motion of the optics assembly in at least one operating mode.

19. The additive manufacturing system of claim 18, further comprising at least one actuator operatively coupled to the first duct and the second duct to selectively move the first duct and the second duct between the retracted configuration and the extended configuration.

20. The additive manufacturing system of claim 19, wherein the at least one actuator is configured to selectively move the first duct and the second duct between the retracted configuration and the extended configuration based on a direction of motion of the optics assembly.

21. The additive manufacturing system of claim 20, wherein, when the first duct is located at least partially ahead of the melted portion of the layer of material relative to the direction of motion of the optics assembly, the actuator is configured to move the first duct into the retracted configuration and to move the second duct into the extended configuration, and wherein, when the second duct is located at least partially ahead of the melted portion of the layer of material relative to the direction of motion of the optics assembly, the actuator is configured to move the first duct into the extended configuration and to move the second duct into the retracted configuration.

22. The additive manufacturing system of claim 15, wherein the gas flow head further comprises a first vent and a first shutter, the first shutter being configured to be selectively moved between an open configuration allowing gas flow through the first vent and a closed configuration preventing gas flow through the first vent, and wherein the gas flow head further comprises a second vent and a second shutter, the second shutter being configured to be selectively moved between an open configuration allowing gas flow through the second vent and a closed configuration preventing gas flow through the second vent.

23. The additive manufacturing system of claim 15, wherein the gas flow head further comprises at least one vent and at least one shutter, the at least one shutter being configured to be selectively moved between an open configuration allowing gas flow through the first vent and a closed configuration preventing gas flow through the first vent.

24. The additive manufacturing system of claim 23, further comprising at least one actuator operatively coupled to the at least one shutter to selectively move the at least one shutter between the open configuration and the closed configuration.

25. The additive manufacturing system of claim 24, wherein the at least one actuator is configured to selectively move the at least one shutter between the open configuration and the closed configuration based on the direction of motion of the optics assembly.

26. The additive manufacturing system of claim 15, wherein the first duct includes at least one gas knife oriented towards a gas outlet of the first duct.

27. A method for additive manufacturing comprising:
directing laser energy from one or more laser energy sources through an optics assembly and toward a build surface, wherein the optics assembly is movable in a scan direction relative to the build surface;
exposing a layer of material on the build surface to the laser energy;
melting at least a portion of the layer of material due to exposure of the portion to the laser energy;
generating a non-uniform flow of gas that flows through a gas flow head in a direction that is at least partially opposite a direction of motion of the optics assembly; and
entraining particles ejected from the melted portion of the layer of material in the non-uniform flow of gas in order to remove the ejected particles from the partially enclosed volume.

28. The method of claim 27, wherein generating the non-uniform flow of gas through the gas flow head comprises generating a flow of gas having a velocity that is higher in a first portion of the gas flow head than in a second portion of the gas flow head.

29. The method of claim 28, wherein the first portion of the gas flow head is at least partially behind the melted portion of the layer of material relative to the direction of motion of the optics assembly and the second portion of the gas flow head is located at least partially ahead of the melted portion of the layer of material relative to the direction of motion of the optics assembly.

30. The method of claim 28, wherein the first portion of the gas flow head is a first duct of the gas flow head and the second portion of the gas flow head is a second duct of the gas flow head.

31. The method of claim 30, further comprises when the first duct is at least partially behind the melted portion of the layer of material relative to the direction of motion of the optics assembly:
moving the first duct into an extended configuration proximate to the build surface, and
moving the second duct into a retracted configuration spaced apart from the build surface.

32. The method of 31, further comprising when the second duct is at least partially behind the melted portion of the layer of material relative to the direction of motion of the optics assembly:
moving the first duct into the extended configuration proximate to the build surface, and
moving the second duct into the retracted configuration spaced apart from the build surface.

33. The method of claim 30, further comprising:
when the first duct is at least partially behind the melted portion of the layer of material relative to the direction of motion of the optics assembly:
moving a first shutter of the first duct into a closed configuration to prevent a flow of gas through a first vent of the first duct, and
moving a second shutter of the second duct into an open configuration to allow a flow of gas through a second vent of the second duct; and

34. The method of claim 33, further comprising:
when the second duct is at least partially behind the melted portion of the layer of material relative to the direction of motion of the optics assembly:
moving the first shutter of the first duct into the open configuration to allow the flow of gas through the first vent of the first duct, and
moving the second shutter of the second duct into the closed configuration to prevent the flow of gas through the second vent of the second duct.

35. The method of claim 30, further comprising flowing gas through an air knife of the first duct towards a gas outlet of the first duct.
